(19) United States
(12) Patent Application Publication
(10) Pub. No.: US 2007/0277967 A1
(43) Pub. Date: Dec. 6, 2007

(54) Separation Of Crude Oil At The Well Head

(76) Inventor: Stein Egil Oserod, Negros Oriental (PH)

Correspondence Address: JACOBSON HOLMAN PLLC, 400 SEVENTH STREET N.W., SUITE 600, WASHINGTON, DC, 20004, US

(21) Appl. No.: 10/586,526

(22) PCT Filed: Jan. 20, 2005
(86) PCT No.: PCT/IB05/00142

§ 371 Date: Jun. 6, 2007

(30) Foreign Application Priority Data
Jan. 20, 2004 (DK) PA 2004 00068

(51) Int. Cl. B01D 19/00

(52) U.S. Cl. 166/75.12

(57) ABSTRACT

The initial separation of the fluid provided from an oil well using a separator previously known only from the area of degassing and flotation of process water from oil recovery.

### FIELD OF THE INVENTION

The present invention relates to separation of a mixture provided at the well head comprising crude oil, gas, water and solids into these constituents.

In particular the present invention relates to the use of a separator previous used as a combined degassing and flotation tank for the separation at the well head of an oil well for the initial separation into crude oil, gas, water and solids.

### BACKGROUND FOR THE INVENTION

In the oil industry the production of crude oil involves a mixture of oil, gas and water from subterranean reservoirs. At the well-head a initial separation usually takes place in one or more stages to remove more water and gas before the crude oil is ready for discharge for export.

After the initial separation the crude oil and the gas may be further purified prior to discharge for refining etc. The water and sand is usually optionally after further purification discharged into a suitable recipient such as the sea or into the reservoir.

With maturing of the oil and gas fields one often finds that the volume of water accompanying the oil and gas becomes much larger and consequently the larger volumes must be treated at the well head in order to maintain an acceptable production rate.

On oil and gas production platforms intended for operation offshore limited space is usually available. Therefore there are very strict constraints on the space available for installation of equipment. An even stricter constraint on space maybe encountered if one considers the establishment of production and separation at the sea bed level.

In the prior art a number of oil-gas-water separators are known. In U.S. Pat. No. 4,424,068 a separator and a method for separating a mixture of oil, gas and water, such as may be received from an oil-well is described. The separator is in the form of a vessel divided into separation chambers and provided with a number of baffles and a dynamic separator where the incoming mixture changes direction several times. Despite that the separator have been known for several years it seems not to have been widely used. Further as the separator comprises several chambers and many parts the maintenance will be time consuming which may lead to costly stop of oil production.

WO 99/20873 describes a sand trap that may be placed on an oil well in order to remove heavier particles such as sand before further processing of the crude oil. The device has a mouth towards a relatively narrow part of a tank with a spatial connection towards a relatively widened part of the tank where sand and heavy particles precipitate.

Despite the number of known separation equipment for the initial separation at the well head there is still a need for a new separation method providing a high separation efficiency, high capacity, low space requirement, with a low requirement for maintenance and which can be manufactured and operated at moderate price.

### BRIEF DESCRIPTION OF THE INVENTION

These objects may be provided by using a separator as disclosed in WO 02/41965 A2 at the well head or well stream for performing the initial separation of the fluids coming from the oil well. WO 02/41965 A2 is incorporated in the present application by reference.

It has surprisingly been realized by the present inventors that the combined degassing and flotation tanks of WO 02/41965 A2 can be applied as a separator directly connected to the well head and perform the initial separation of the fluids from the oil and gas reservoir into a oil fraction, a gas fraction, a water fraction optionally with solids.

### BRIEF DESCRIPTION OF THE DRAWINGS

FIG. 1 is a schematic section of the combined degassing and flotation tank according to WO 02/41965. In the figure (1) is the tank, (2) the tangential inlet, (3) outlet for oil and gas, (4) outlet for water, (8) outlet for solids, (10) inner cylinder and (11) inlet guide vane.

FIG. 2 is a schematic depiction of an arrangement of combined degassing and flotation tanks used for the initial separation of fluid from an oil and gas producing well.

FIG. 3 is a schematic depiction of combined degassing and flotation tanks in series.

FIG. 4 is a schematic depiction of combined degassing and flotation tanks in parallel.

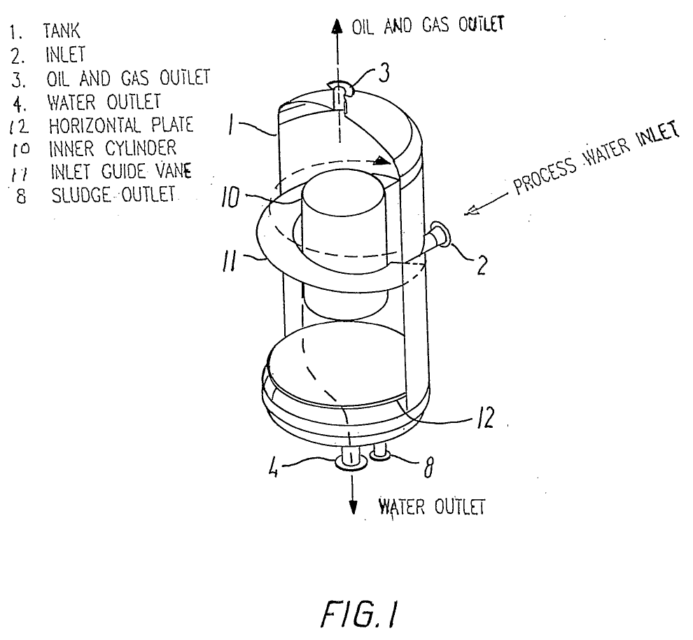

### DETAILED DESCRIPTION OF THE INVENTION

In the preferred embodiment of the present invention the separator used for the separation comprises an essentially cylindrical vertical tank (1), with a tangentially arranged inlet (2) at least one outlet (3) for oil and gas in the upper part of the tank, an outlet (4) for water placed in the lower part of the tank, an inner concentrically wall (10) formed as a cylinder placed in the upper part of the tank leaving an open space between said cylinder and the top of the tank, and further leaving a space between said cylinder and the bottom of the tank, an optional outlet (8) for solids placed in the lower part of the tank, and provided with an inlet guide vane (11) placed between the tank (1) and the inner cylinder (10) leaving an open space between the inner cylinder and the inlet guide vane (11), and further optionally provided with a concentrically arranged horizontal circular plate (12) having a smaller diameter that the tank placed in the lower part of the tank above the outlet for water (4) and optional outlet for solids (8). The plate (12) may serve as a vortex breaker during operation of the tank.

If the separator to be used according to the invention contains only one outlet for oil and gas the oil and gas will be provided from the separator as one oil/gas fraction which subsequently may be separated to oil and gas fractions in an additional separation stage.

In an optional embodiment the separator contains separate outlets for oil and gas. Both outlets will be placed in the top part of the tank with the outlet for gas above the outlet for oil. However, the skilled person will appreciate how to arrange the apertures of the outlets for oil and gas in order to obtain separate fractions.

Further details of the separator to be used according to the invention can be found in WO 02/41965.

After the initial separation of the fluid from the reservoir the water and oil fractions will still contains some dissolved gas that may subsequently be removed using a further separator, preferably a degassing and flotation tank as described above. The amount of gas contained in the gas and oil fractions will depend on the actual conditions in the separator such as temperature, pressure and residence time.

Fluids to be separated according to the present invention are fluids coming directly from the well, communicating with an oil and gas reservoir. Such fluids is composed of varying amounts of hydrocarbons, water and optional other constituents. There is no lower or upper limit for the content of hydrocarbons in the fluid to be treated according to the invention. Beside hydrocarbons the remainder in the fluid is usually water, non-hydrocarbonaceous gases and solids, such as sand and other minerals present in the subsurface. The fluid may also contain chemicals added to the subsurface in order to improve the amount of oil that can be recovered, as a skilled person will know.

In order to improve the separation it may advantageously to inject gas into the fluid before entering the separator. The gas is preferably a hydrocarboneous gas, suitable recycled gas from the oil and gas production.

The separator will usually be operated at a pressure determined mainly of the pressure with which the fluid leaves the well head, however the pressure may also be increased or reduced before entering the separator using known procedures. The separator may be operated at a pressure corresponding to atmospheric pressure and upwards.

The dimensions of the separator may be selected depending on the amounts of fluid intended to be treated. In operation is has been found that the residence time in the tank for a fluid to be treated should be from about 20 seconds and upwards, preferably the residence time is in the range 20 to 300 seconds, more preferred 25 to 240 seconds.

For the combined degassing and flotation tank according to the invention, an efficient flotation volume may be calculated as the volume of the space bounded by the tank (1) and the height of the liquid in the tank. Based on the residence time the capacity of the tank may be calculated e.g. a tank with a efficient flotation volume of 1 m³ and a residence time for the liquid of about 30 seconds has a capacity of treating about 100 m³ fluid per hour.

The ratio of height to diameter of the tank can be selected within wide limits preferably in the range of 1:1 to 4:1 more preferred from 1:1 to 2:1.

It is within the skills of a person skilled in the art to select materials used for the construction of the tank based on the actual conditions for the intended use, such as the amounts of liquid to be treated, the composition of said liquid, the selected pressure, the temperature of the liquid and the presence of possible corrosive chemicals in any of the phases of the mixture.

During operation the rate with which the separated phases are withdrawn via the respective outlets determines where the interphases between gas and oil, oil and water and water and solids are located in the tank. The skilled person will appreciate how to adjust the rate of withdrawal via the respective outlets so that the optimal separation will be achieved.

Because of the way the separators according to WO 02/41965 are constructed with all surfaces vertical or at least having a steep inclination except for guide vane and vortex breaker. Further no narrow passages are present in the tank. Consequently there is no place in the separator, which is susceptible to clogging or deposition of solid materials. Therefore the initial separation of the fluid at the well head may be performed essentially continuously without or only with a minimal need for maintenance.

Further maintenance, when it is necessary even though it is infrequent, can easily be performed due to the well-thought-out design of the separator.

Thus the separation of the fluid at the well head or in the well stream according to the invention has a remarkable robustness i.e. it can be run for long periods without interruptions, and the few stops that may be required for maintenance can be made short.

The high capacity combined with the minimum space requirements and the robustness of the separation according to the invention makes it particular suited for use at off-shore installations such as oil and gas product ion platforms. Further it is also well suited for use in oil and gas production located on the sea bed, because at such a location the constraints on space may be even stricter than on traditional oil and gas production platforms and the capacity for maintenance may be lower. Consequently, the separator is highly useful in oil and gas production both on-shore and off-shore.

Now the invention is described by examples, which should not be regarded as limiting for the invention.

### EXAMPLES

1. Use of Three Combined Degassing and Flotation Tanks as Separators for Three Phase Separation.

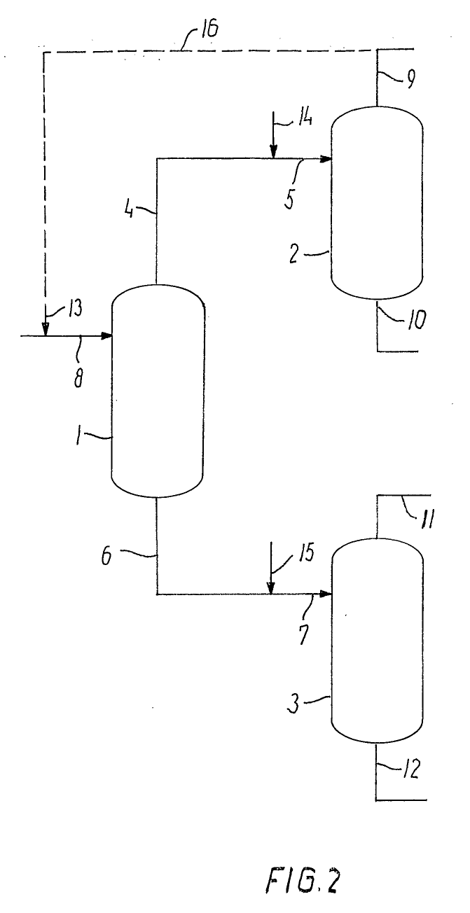

With reference to FIG. 2 the use of the combined degassing and flotation tanks for separating a well stream comprising oil, gas and water is schematically depicted.

The use includes three separator tanks 1, 2 and 3 according to the invention. The outlet for oil and gas 4 of tank 1 is connected to the inlet 5 on tank 2. Likewise the outlet for water 6 of tank 1 is connected to the inlet 7 on tank 3.

The fluid from the well head is lead to tank 1 via inlet 8. In tank 1 the fluid is separated into a gas and oil phase and a water phase. The gas and oil phase is taken out from tank 1 via outlet 4 and lead to tank 2 via inlet 5. The water phase is taken out from tank 1 via outlet 6 and lead to tank 3 via inlet 7.

In the tank 2 the gas and oil phase is separated into gas, which leaves tank 2 via outlet 9, and oil, which leaves tank 2 via outlet 10.

In tank 3 the water phase is separated into water and gas. The gas leaves tank 3 via outlet 11 and the water leaves tank 3 via outlet 12.

In order to improve the separation in the tanks 1, 2 and 3 further gas may be injected into the incoming streams at 13, 14 and 15, respectively. The gas for injection may be a part of the recovered gas from outlet 9, as indicated by dotted line 16.

By the described arrangement a fluid from a well head comprising oil, gas and water is very effectively separated into an oil phase, a gas phase and a water phase, where the water phase is more than 99% pure.

2. Use of Three Combined Degassing and Flotation Tanks as Separators in Series.

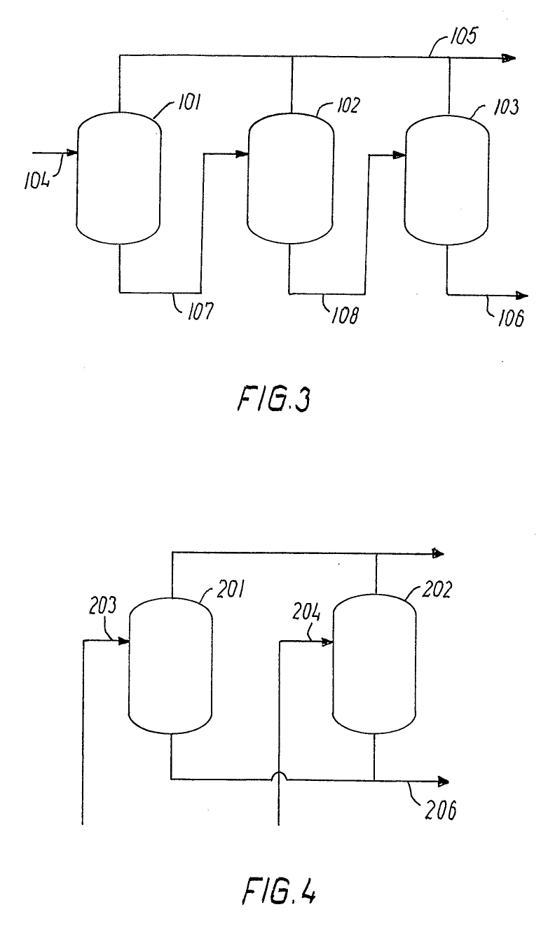

FIG. 3 depicts schematically three tanks 101. 102, and 103 connected in series for separating a well stream 104 from a well head into an oil/gas phase 105, and a water phase 106. The well stream 104 may be water comprising 1000 ppm impurities (gas/oil). Subsequent to treatment in tank 101 the water stream in line 107 comprises 100 ppm impurities. The stream 107 is lead to treatment in tank 102 and the water stream 108 from tank 102 comprises 10 ppm impurities. The stream 108 is finally treated in tank 103 and thus providing a water stream 106 with less than 5 ppm impurities.

This arrangement may optionally be used for further treatment of the water 12 from tank 3 in example 1.

The oil/gas phase may be separated into oil and gas by treatment in a further tank as described in example 1. Optionally the oil/gas phase may be separated in two or more tanks in series.

3. Use of combined degassing and flotation tanks as separators in parallel.

FIG. 4 depicts schematically an arrangement where two tanks 201 and 202 are used in parallel. Fluid from a well head enters tanks 201 and 202 at 203 and 204. And oil/gas phase is taken out at 205 and a water phase is taken out at 206. The oil/gas phase and the water phase may be further treated as described in example 1 and 2.

FIG. 2, 3 and 4 are only schematically and the arrangements may comprise further equipment normally used in oil and gas production like e.g. valves, pumps, compressors, further pipelines, which are excluded for simplicity. However, the arrangement described above can easily be adapted for specific use by a skilled person.

Moreover, it is evident that the combined degassing and flotation tanks according to the invention can be used combined in any desired arrangement, e.g. in series and/or in parallel.

1. Use of at least two separators, each separator comprising an essentially cylindrical vertical tank (1), a tangentially arranged inlet (2), at least one outlet (3) for oil and gas in the upper part of the tank, an outlet (4) for water placed in the lower part of the tank, an inner concentrical wall (10) formed as a cylinder placed in the upper part of the tank leaving an open space between said cylinder and the top of the space, and further leaving a space between said cylinder and the bottom of the tank, an outlet (8) for solids placed in the lower part of the tank, and optionally provided with an inlet guide vane (11) placed between the tank (1) and the inner cylinder (10) leaving an open space between the inner cylinder and the inlet guide vane (11), and further optionally provided with a concentrically arranged horizontal circular plate (12) having a smaller diameter than the tank placed in the lower part of the tank above the outlet for water (4) and solids (8), for the initial separation at the well of the fluid from an oil and gas reservoir, wherein the fluid is subjected to gas injection for improved separation in at least one of said separator tanks.

2. Use according to claim 1, wherein the fluid from an oil and gas reservoir is subjected to gas injection before entering the separator tank.

3. Use according to claim 1, wherein the gas for gas injection is a hydrocarboneous gas.

4. Use according to claim 1, wherein the gas for injection is gas recycled from the oil and gas production.

5. Use according to claim 1, wherein two or more separator tanks are used in series.

6. Use according to claim 1, wherein two or more separator tanks are used in parallel.

7. Use according to claim 1, wherein the pressure in separator the tank is from atmospheric pressure and up.

8. Use according to claim 1, wherein the initial separation comprises treatment of about 100 m³ fluid per hour per 1 m³ separator tank volume.

9. Use according to claim 1, wherein the fluid in separated into an oil/gas phase and a water phase.

10. Use according to claim 9, wherein the oil/gas phase is separated into an oil phase and a gas phase in an additional stage.
